(19) United States
(12) Patent Application Publication
(10) Pub. No.: US 2016/0261921 A1
(43) Pub. Date: Sep. 8, 2016

(54) CONTEXT BASED SHOPPING CAPABILITIES WHEN VIEWING DIGITAL MEDIA

(71) Applicant: Dante Consulting, Inc., Arlington, VA (US)

(72) Inventor: Pierre Malko, Arlington, VA (US)

(73) Assignee: Dante Consulting, Inc, Arlington, VA (US)

(21) Appl. No.: 15/157,134

(22) Filed: May 17, 2016

Related U.S. Application Data
(63) Continuation-in-part of application No. 13/839,919, filed on Mar. 15, 2013.
(60) Provisional application No. 61/729,273, filed on Nov. 21, 2012.

(51) Int. Cl. H04N 21/478

(52) U.S. Cl. CPC H04N 21/47815; G06Q 50/14

(57) ABSTRACT

The embodiments herein relate to facilitating the display of relevant content to a user, such as relevant offers and advertisements, during a presentation of streaming media content. A first device contextualizes data associated with media content, which includes generating one or more metadata tags associated with respective segments of the media content. In response to a request to stream the media content on a second device in communication with the first device across a network, the second device presents the media content received from a provider across the network. The first device dynamically interacts with the second device during the viewing of the video by performing an analysis based on the contextualized data. The first device transmits a relevant content communication, such as an alert, to the second device based on the analysis. The second device causes a presentation of the relevant content, either on a visual display in communication with the second device, or on a third device in communication with the first and second devices across the network.

### CROSS REFERENCE TO RELATED APPLICATION(S)

This application is a continuation-in-part of U.S. patent application Ser. No. 13/839,919, filed on Mar. 15, 2013 and titled “Context Based Shopping Capabilities When Viewing A Digital Image,” which is a non-provisional patent application claiming the benefit of the filing date of U.S. patent application Ser. No. 61/729,273, filed on Nov. 21, 2012 and titled “Context Based Shopping Capabilities When Viewing A Digital Image,” which are hereby incorporated by reference.

### BACKGROUND

The embodiments described herein relate to connecting product information with digital image data. More specifically, the embodiments relate to establishing connections between digital image data and product data to enable selection and query of the product data.

Digital media, also referred to herein as digital image data, generally pertains to a numeric representation of an image in a digital media environment. Digital media may come in different forms including, but not limited to, still images, graphic images, motion data, etc. Use of digital media continues to grow, as demonstrated through different forms of electronic commerce and electronic communication.

In the commercial environment, digital media has become common through digital content of news and information. For example, hardcopies of magazines and newspapers are commonly available in digital form. To support costs associated with creation and distribution of the digital content, electronic advertisement is supported. Both the content and the advertisement(s) may include associated digital image(s). In one embodiment, the digital image(s) may be in the form of product endorsement. One focus of presenting digital image data is to attain the attention of a consumer. Electronic advertising, including but not limited to television video advertising, web video advertising, etc., tends to be presented at specific intervals with the same advertising content broadcast to viewers without taking into account individual preferences.

### BRIEF SUMMARY

The aspects described herein comprise a system, computer program product, and method for transmitting relevant secondary content, such as relevant offers and advertisements, in real-time during streaming of video content, wherein the secondary content is relevant to both the streaming content and the viewer.

According to one aspect, a system is provided to facilitate a presentation of relevant content associated with streaming media content. The system includes a first device in communication with a second device across a network. The first device comprises a first processing unit and a first memory, and the second device comprises a second processing unit and a second memory. The first device contextualizes data associated with media content, which in one embodiment includes generating one or more metadata tags associated with respective segments of the media content. In response to a request to stream the media content on the second device, the second device presents the media content received from a provider across the network. The first device dynamically interacts with the second device during the viewing of the video by performing an analysis based on the contextualized data. The first device transmits a relevant content communication, such as an alert, to the second device based on the analysis. The alert causes presentation of the relevant content, either on a visual display in communication with the second device, or on a third device in communication with the first and second devices across the network.

According to another aspect, a computer program product is provided to facilitate a presentation of relevant content associated with streaming media content. The computer program product comprises first and second computer-readable non-transitory storage media having first and second computer readable program code embodied thereon, respectively. The first storage medium is associated with a first device and the second storage medium is associated with a second device. The first and second devices are in communication across a network. The first and second program code is executable by first and second processors, respectively, to present relevant content associated with streaming media content. The first program code contextualizes data associated with media content, which includes generating one or more metadata tags associated with respective segments of the media content. In response to a request to stream the media content on the second device, second program code presents the media content received across the network from a media provider. First program code dynamically interacts with the second device during the presentation of the media content by performing an analysis based on the contextualized data. First program code transmits a relevant content communication, such as an alert, to the second device based on the analysis. The alert causes a presentation of the relevant content, either on a visual display in communication with the second device, or on a third device in communication with the first and second devices across the network.

According to yet another aspect, a method is provided facilitating a presentation of relevant content associated with streaming media content. A first device contextualizes data associated with media content, which in one embodiment includes generating one or more metadata tags associated with respective segments of the media content. In response to a request to stream the media content on a second device in communication with the first device across a network, the second device presents the media content received across the network from a media provider. The first device dynamically interacts with the second device during the presentation of the media content by performing an analysis based on the contextualized data. The first device transmits a relevant content communication, such as an alert, to the second device based on the analysis. The alert causes a presentation of the relevant content, either on a visual display in communication with the second device, or on a third device in communication with the first and second devices across the network.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 depicts block diagram illustrating one embodiment of a system to dynamically present secondary content based on streaming media.

FIG. 2 depicts a block diagram illustrating another embodiment of a system to dynamically present secondary content based on streaming media.

FIG. 3 depicts an example of a contextualized scene of video data.

FIG. 4 depicts a block diagram illustrating a node of a cloud computing environment.

FIG. 5 depicts a block diagram illustrative of a cloud computing environment.

FIG. 6 depicts a block diagram illustrating a set of functional abstraction model layers provided by the cloud computing environment of FIG. 5.

FIG. 7 depicts a flow chart illustrating a method for dynamically presenting secondary content based on streaming media.

FIG. 8 depicts a flow chart illustrating a method for dynamically presenting secondary content based on streaming media.

FIG. 9 depicts a diagram illustration a relationship of client metadata and streaming media metadata.

FIG. 10 depicts a flow chart illustrating a method for contextualizing streaming media content.

FIG. 11 depicts a flow chart illustrating a method for enhancing contextualized streaming media data.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of a manager, to provide a thorough understanding of embodiments of the invention. One skilled in the relevant art will recognize, however, that the invention can be practiced without one or more of the specific details, or with other methods, components, materials, etc. In other instances, well known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

Conventional advertising associated with transmitted media is presented at specific intervals. For example, while a consumer is watching television in a conventional viewing environment (e.g., cable, satellite, antenna, etc.), advertisements are broadcast to all viewers of a specific show at various times during viewing of the television program (i.e., at scheduled commercial breaks). In the case of streaming media, such as via the Internet or on-demand services, the advertisements are also presented at select viewing times. In one embodiment, one or more advertisements are broadcast at the beginning of the streaming media presentation to enable uninterrupted viewing of the streaming video. In another embodiment, one or more advertisements are broadcast at preset time intervals during the streaming media presentation. In addition, the advertisements are presented to the viewer regardless of relevancy with respect to the viewer, and may or may not be related to the subject matter of the media being consumed. Accordingly, whether they are presented during a conventional television broadcast or in the context of streaming media, advertisements are commonly considered a nuisance by the viewer since there is minimal or no relationship of the product or service that is the subject of the advertisement and the specific interests of the viewer.

As shown and described in the figures below, advertisements, offers, and other content, hereinafter referred to as secondary media content, or secondary content, are presented to the viewer with the goal of converting advertising from a nuisance to a value added service. More specifically, control over the presentation of the secondary content is changed from the video service provider to the consumer. In one embodiment, this changed control is also referred to as an on-demand content model. Accordingly, control of the secondary media is inverted from the conventional advertisement model, with control resting entirely with the content provider, to control managed by the consumer.

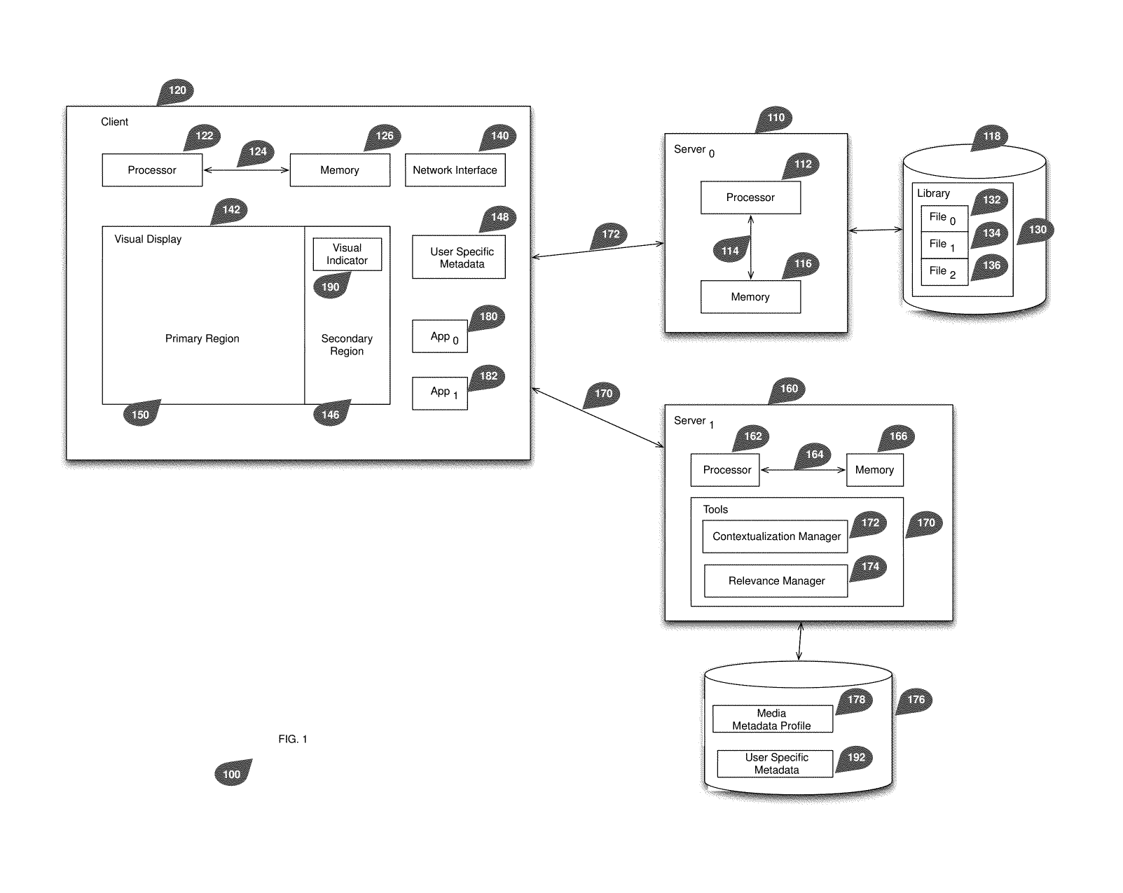

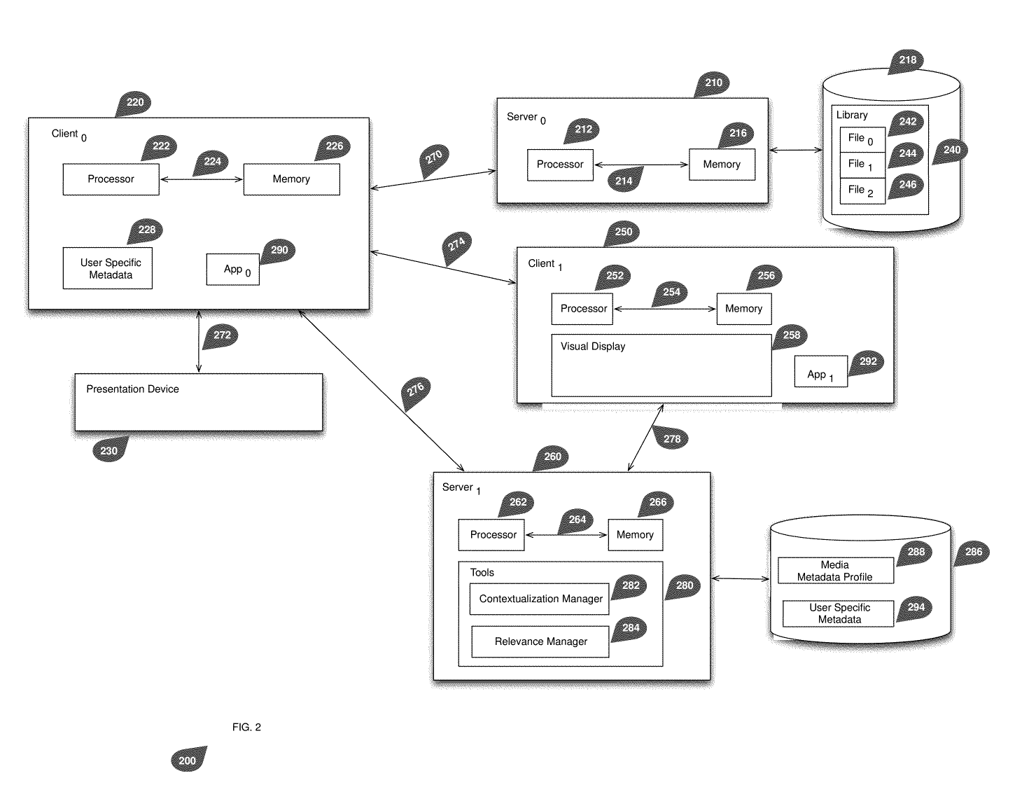

With reference to FIG. 1, a system (100) is provided to dynamically present relevant secondary content based on the streaming media content. The system (100) includes one or more entities in communication over a communication network (e.g., the Internet). As shown, the system (100) includes a first server (110) in communication with a client machine (120) across a network connection in the form of a streaming channel (172). The client machine (120) may be a computing device, such as a personal computer, laptop, smart phone, tablet, wearable device, or any other mobile device. In another embodiment, the client machine may (120) may be a device in communication with a television or entertainment system, such as a set-top box or digital media player (not shown). The first server (110) is shown with a processor (112) in communication with memory (116) across a bus (114). In one embodiment, the first server (110) is associated with a streaming media provider which is in communication with data storage (118). In one embodiment, the data storage (118) may be a data center. Similarly, in one embodiment, the first server (110) is a cloud based resource available to multiple client machines across the network connection (105).

Data storage (118) is shown with a digital media library (130) with a plurality of media files, including media files (132)-(136). In one embodiment, the media files include one or more video files. Although only three media files are shown herein, this quantity should not be considered limiting. Based on selection of a media file from the digital media library (130) for streaming by the client machine (120), such as a selection of media file (132), streaming of the selected media file (132) may be initiated from the streaming media provider (110) to the client machine (120) across the network (105). The client machine (120) is shown configured with a processor (122) in communication with memory (126) across a bus (124). The client machine (120) is further configured with a network interface (140) to support wired and wireless network communication with the first server (110) and any other machines. The client machine (120) is further shown with a visual display (142).

The client machine (120) may be associated with a person logged onto the machine, also referred to herein as a user. In one embodiment, the client machine (120) permits access to a single user while, in another embodiment, the client machine (120) permits shared access among a plurality of users. Regardless of the shared nature of the client machine (120), each user who utilizes the machine has respective computing characteristics embodied as metadata, referred to herein as user-specific metadata. In general, metadata is a set of data that describes and gives information about other data. With respect to user-specific metadata, this may include metadata pertaining to user preferences, historical behavior, algorithmic interferences, and user environment (e.g., season, weather, time of day, month, etc.). As shown herein, the user-specific metadata (148) is stored local to the client device (120). In one embodiment, the user metadata (148) is comprised within a user profile stored in memory (not shown). The user-specific metadata (148) may include an initial set of metadata that is subject to change as characteristics of the user are dynamically updated. More specifically, as the user continues to employ the client machine (120) for various tasks, or as the environmental metadata changes over time, associated characteristics are gathered and appended to the user metadata (148).

In one embodiment, and as shown, the client machine (120) is in communication with a second server (160). The second server (160) is shown with a processor (162) in communication with memory (166) across a bus (164). In one embodiment, the second server (160) supports a contextual personalized content delivery service, hereinafter referred to as a content delivery service. The content delivery service may be a cloud based resource available to multiple client machines across the network (105). In one embodiment, and as shown, the server (160) includes one or more tools (170). The tools may include a contextualization manager (172) and a relevance manager (174). The user-specific metadata (148) may be stored remotely from the client device (120) at the second server (160), either separately or in addition to the local storage on the client machine (120).

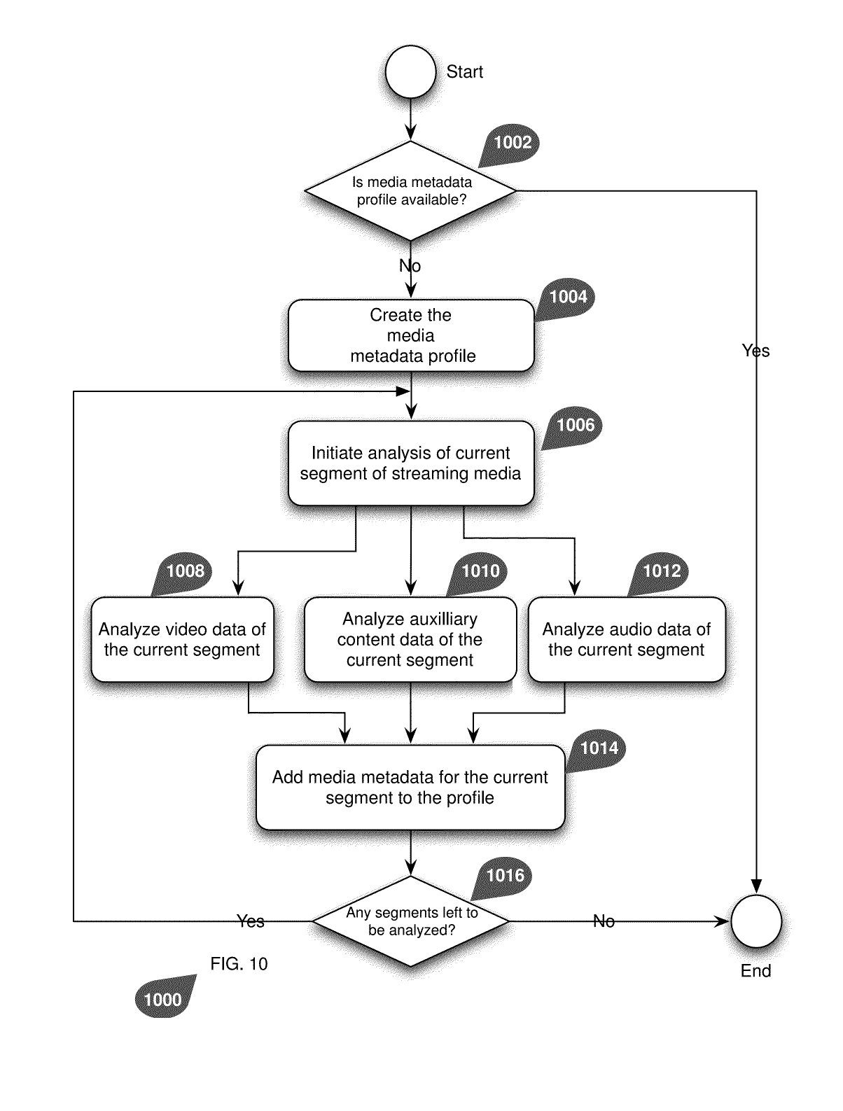

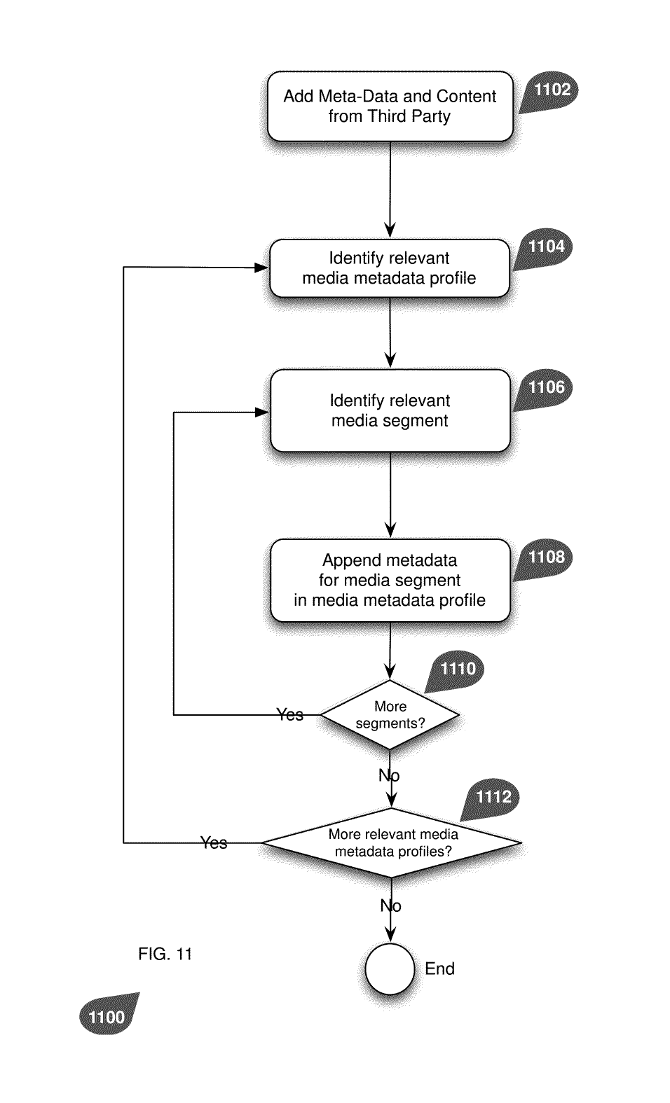

The contextualization manager (172) supports contextualization of media data, such as streaming media data. In one embodiment, the contextualization manager (172) generates metadata tags (“tags”) associated with media content, such as primary content associated with the selected media file (132). For instance, the contextualization manager may analyze and extract video data, audio data, and/or any auxiliary or embedded data from the media file (132) (e.g., closed captioning data) associated with respective segments of the streaming primary content, and generate tags for each segment based on the analysis and extraction. In one embodiment, each segment is a scene or frame of a video. The purpose of the tag generation is to annotate or otherwise describe segments of the primary content. The server (160) is shown in communication with data storage (176). In one embodiment, the data storage (176) may be a data center. In one embodiment, the contextualized data (e.g., the generated metadata tags) are stored at the data storage (176). However, the contextualized data may be stored at any storage device in communication with the second server (160). In one embodiment, and as shown, media metadata profile (178) and user specific metadata (192) are stored in the data storage (176). Further details regarding the process for contextualizing media data are provided below with reference to FIGS. 10 and 11.

The tags generated by the contextualization manager (172) may describe various characteristics or aspects of a segment (e.g., scene or frame), including but not limited to location, visible objects, associated events, specific establishment or venues, associated activities, audio soundtrack, background music, topics of conversation, etc. For example, a scene may depict two people dining at a restaurant. Tags may be generated, based on video data, audio data, and/or auxiliary or embedded data, to describe the venue itself, such as the restaurant and related features (e.g., cuisine, rating, type of service, visible objects within the scene, etc.), the location of the restaurant (e.g., neighborhood, city, town, etc.), activities associated with the scene (e.g., eating dinner, discussing a specific topic), music associated with the scene, and any other characteristics associated with the scene.

An application is a self-contained program or piece of software designed to fulfill a particular purpose. As shown herein, two applications are provided to support the inversion of advertisement control. In one embodiment, the applications may be combined into a single application, or the applications may be further separated into multiple applications. Accordingly, the quantity of applications to support the advertisement control should not be considered a limiting feature.

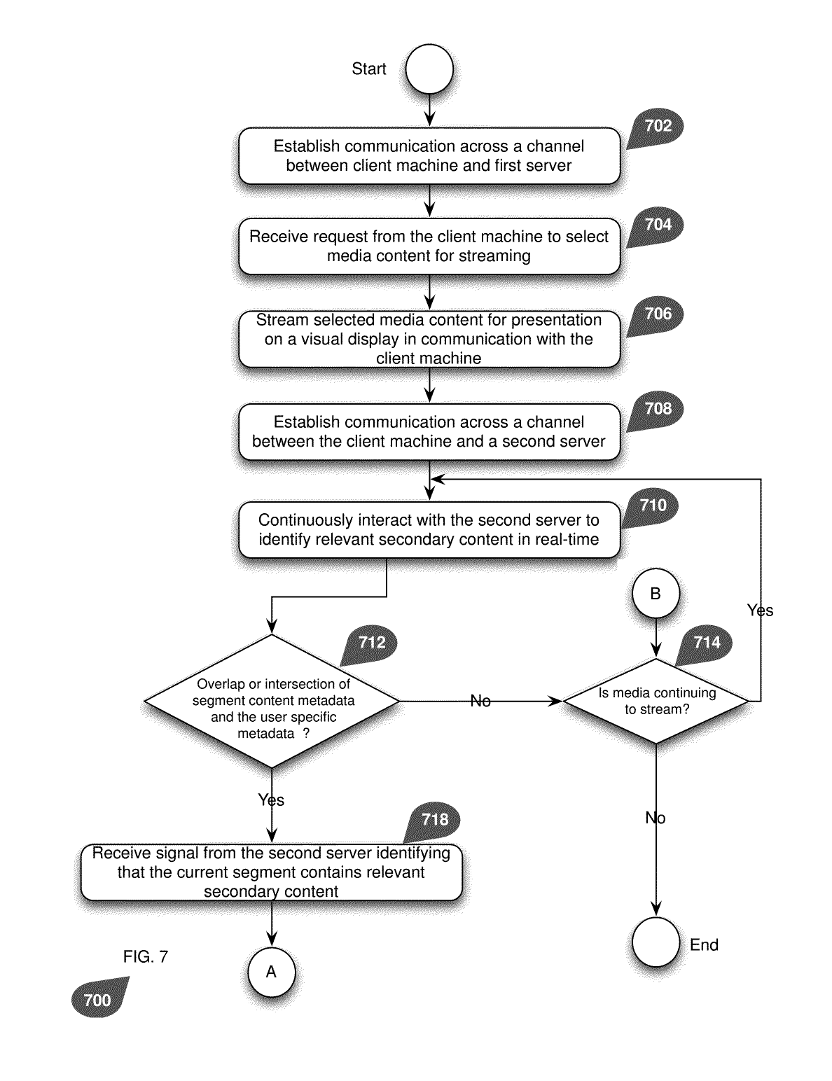

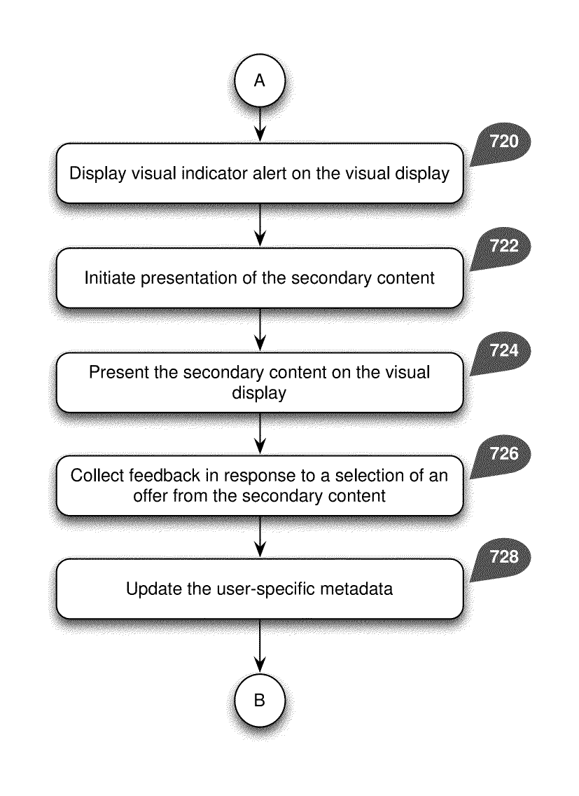

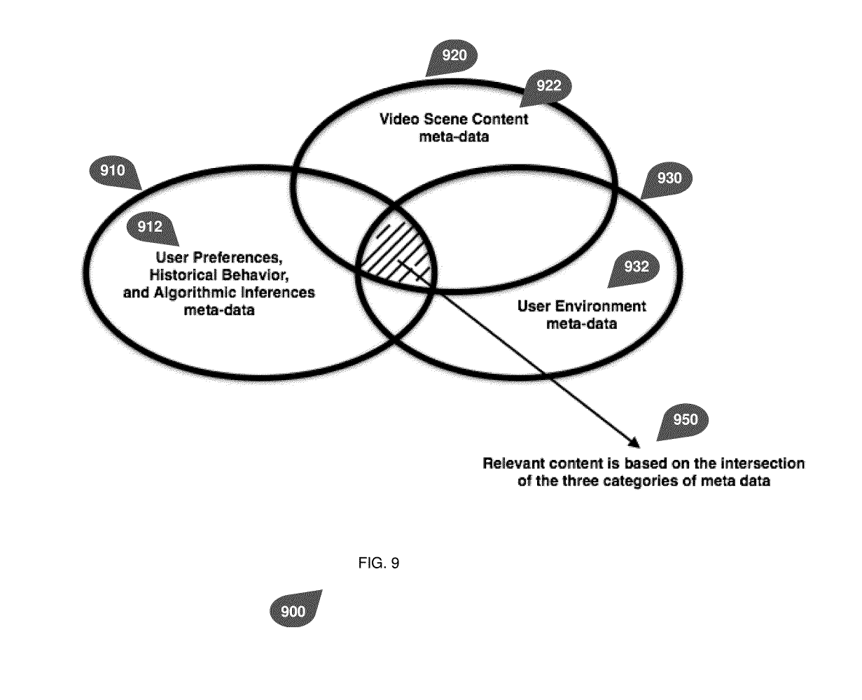

A first application, APP₀, (180) is shown embedded in the client machine (120) and in communication with the processor (122). APP₀ (180) functions to dynamically assess a relevance of the secondary content based on the particular user viewing the primary content. More specifically, APP₀ (180) interfaces with the relevance manager (174) of the server (160) in real-time to dynamically assess a relevance of a segment of the primary content being streamed. In one embodiment, the relevance assessment is based on the user metadata (148). During the streaming of the primary content, the relevance manager (174) compares the user metadata (148) (e.g., user preference, historical behavior, algorithmic inference, and environmental metadata) to characteristics of the streaming content, such as the media metadata tags from the profile (178) associated with a current segment of the streaming primary content. In one embodiment, the relevance manager (174) may conduct this assessment at the initial streaming of the primary content. In another embodiment, the relevance manager (174) functions to continuously compare the media metadata (178) with the user metadata (148) while the primary content is streaming. As such, if the initial assessment does not indicate segment relevance, a later assessment may indicate such relevance. Further details with respect to the relevance assessment process are provided below with reference to FIGS. 7 and 9. Accordingly, a continuous interaction between the client machine and the content delivery service supports a dynamic relevance assessment.

The system may be configured to stream advertisements and/or commercial offers to the client machine (120) in response to the dynamic assessment determining that a current segment of the streaming media content is user-relevant. In one embodiment, if the relevance manager (174) identifies that a current segment of the streaming media content contains relevant content, it issues a response signal to the APP₀ (180). The response signal may include a token that contains identifying properties of the relevant content.

The receipt of the response signal, e.g., the token, by the client machine (120) functions to identify relevant secondary content in the context of the streaming media. In one embodiment, the receipt of the response signal causes an activation of a secondary application (“APP₁”) (182) on the client machine (120). APP₁ (182) functions to present a visual indicator (190) on the visual display (142). The visual indicator (190) serves to indicate the existence of relevant content. The visual indicator (190) may be a form of software code. To prevent an interruption of the presentation of content on the visual display (142), in one embodiment, the APP₁ (182) may control regions, also referred to herein as secondary windows or regions, of the visual display (142). For instance, APP₁ (182) may divide the visual display (142) into a primary region (150) and an adjacently positioned secondary region (146), and display the visual indicator (190) in the secondary region (146) while the presentation of the streaming media content is maintained in the primary region (150). In one embodiment, the primary region (150) occupies a majority of the real estate of the visual display (142). One aspect of the separate viewing regions (150) and (146) in the visual display (142) is to prevent the visual indicator (190) from overlapping or occluding the primary content while it continues to stream and, as such, prevent disturbance with user enjoyment of the streaming media content. Accordingly, the separation of the windows and associated content within the visual display (142) reduces interruption during streaming of the media content.

The visual indicator (190) functions as a visual indicator to the user of ascertained relevant secondary content prior to transmission of the secondary content. The visual indicator (190) may be an interactive element, and as such, the secondary content may be transmitted to the client machine (120) for viewing upon manual interaction with the visual indicator (190). For instance, the visual display (142) may include capacitive sensor technology to enable direct communication and interaction with the visual indicator (190). In an alternative embodiment, the secondary content is displayed autonomously (i.e., without requiring manual interaction). Such an autonomous function would impose a requirement on the user to view the secondary content. Thus, if relevant content is present within a current segment of the streaming primary content, the system may support an optional presentation of the secondary content based on a manual interaction with the visual indicator (190), or may require the presentation of the secondary content. Regardless of whether the presentation of the secondary content is based on the manual interaction or autonomous, in one embodiment, the secondary content is communicated from the second server (160) to the client machine (120) across a secondary channel (170) for presentation, while, the primary content is communicated from the first server (110) to the client machine across a separate channel referred to herein as a streaming channel (172). Accordingly, a client machine dynamically interacts with a contextual personalized content delivery service to deliver user-relevant advertisements, offers, etc. in real-time during consumption of streaming media.

In one embodiment, the secondary content may include one or more interactive offers or commercial advertisements. For example, each interactive offer or advertisement may be a hyperlink to an Internet address. The hyperlink may be embedded in text, embedded in an image, etc. Alternatively, in one embodiment, the secondary content may be standalone content and not configured to support interaction. Based on the interactive secondary content, selection of the associated link by the user may activate a view application, such as a web browser, and direct the user to the address dictated by the hyperlink in the secondary region (146). At the same time, as the primary content continues streaming and the user continues to interface with the secondary content, user metadata (148) continues to be generated. In one embodiment, the user metadata (148) is augmented so that it is current and comprehensive. For example, in one embodiment, the client device (120) is portable, and as the location of the client device (120) is updated, geographic identification information is modified. Similarly, the user's interaction with secondary content, such as selection of a specific advertisement, reflects interest, and this data is gathered and stored in the user metadata (148) as a characteristic associated with the user. In one embodiment, the user metadata (148) may reflect user preferences that are subject to change based upon activation of APP₁ (182) and communication with secondary content. Accordingly, a system is provided to deliver relevant content, such as advertisements and offers, in real-time during a presentation of streaming media by analyzing the streaming media in view of user-preferences.

Referring to FIG. 2, a system (200) is provided to dynamically present relevant secondary content based on primary streaming media content. The system (200) includes one or more entities in communication over a communication network (e.g., the Internet). As shown, the system (200) includes a first server (210) in communication with a primary client machine (220) across a first communication channel (270). In one embodiment, the first communication channel (270) is a wireless communication channel. In one embodiment, the primary client machine (220) is a streaming media device for receiving streaming media in the form of visual images, video, and/or audio. For example, the primary client machine (220) may be a set-top box, a digital media player, etc. The primary client machine (220) is shown in communication with a presentation device (230). In one embodiment, the presentation device (220) is a television. Although the presentation device (230) is shown as a television in FIG. 2, the presentation device (230) may be associated with a personal computer, a tablet, a mobile telecommunication device (e.g., a smart phone), etc. In one embodiment, the presentation device (230) may be physically separate from the primary client machine (220) with communication supported across a second communication channel (272). Alternatively, in one embodiment, the primary client machine (220) may be embedded within the presentation device (230).

The primary client machine (220) is shown configured with a processor (222) in communication with memory (226) across a bus (224).The primary client machine (220) may be associated with a person logged onto the machine, also referred to herein as a user. In one embodiment, the primary client machine (220) permits access to a single user while, in another embodiment, the primary client machine (220) permits shared access among a plurality of users. Regardless of the shared nature of the primary client machine (220), each user who utilizes the machine has respective computing characteristics embodied as metadata, referred to herein as user-specific metadata. In general, metadata is a set of data that describes and gives information about other data. With respect to user-specific metadata, this may include metadata pertaining to user preferences, historical behavior, algorithmic interferences, and user environment (e.g., season, weather, time of day, month, etc.). As shown herein, the user-specific metadata (228) is stored local to the client device (220). In one embodiment, the user metadata (228) is comprised within a user profile. The user-specific metadata (228) may include an initial set of metadata that is subject to change as characteristics of the user are dynamically updated. More specifically, as the user continues to employ the client machine (220) for various tasks, or as the environmental metadata changes over time, associated characteristics are gathered and appended to the user metadata (228).

The first server (210) is shown herein as a server configured with a processing unit (212) in communication with memory (216) across a bus (214). In one embodiment, the first server is a streaming media provider, similar to the streaming media provider described above. The streaming media provider (210) is in communication with data storage (218), local or remote. Data storage (218) is shown with a digital media library (240) with a plurality of media files, including media files (242)-(246). In one embodiment, the media files include one or more video files. Although only three media files are shown herein, this quantity should not be considered limiting. In one embodiment, the first server (230) is a cloud based resource available to multiple client machines across the network. Based on selection of a media file from the digital media library (240) for streaming by the primary client machine (220), such as a selection of media file (242), streaming of the selected media file (242) may be initiated from the first server (210) to the primary client machine (220) across the channel (270). The primary client machine (220) presents the streamed media content associated with the selected media file (242) on the presentation device (230). Accordingly, the primary client device (220) functions as an interface between the presentation device (210) and the streaming media provider (230).

As further shown herein, a secondary client machine (250) is provided as a separate entity from the primary client machine (220) and the presentation device (230). In one embodiment, the primary client machine (220) permits access to a single user while, in another embodiment, the primary client machine (220) permits shared access among a plurality of users. The secondary client machine (250) is provided with a processing unit (252) in communication with memory (256) across a bus (254), and is further shown in communication with the primary client machine (220) across a third channel (274). The secondary client machine (250) may be a personal computer, a tablet, a mobile telecommunication device (e.g., a smart phone), etc. As such, the secondary client machine (250) has a visual display (258). In one embodiment, the visual display (258) has a capacitive sensor (not shown) to enable direct communication and interaction with images and video present on the visual display (258).

In one embodiment, and as shown, the primary client machine (220) and the secondary client machine (250) are in communication with a second server (260) across fourth channel (276) and fifth channel (278), respectively. In one embodiment, the second server (260) is a content delivery service, similar to the content delivery service discussed above in FIG. 1. The second server (260) is shown with a processor (262) in communication with memory (266) across a bus (264). For instance, the content delivery server (260) includes one or more tools (280), including a contextualization manager (282) to contextualize streaming media data to create segment content metadata, and a relevance manager (284) to determine a relevance of the streaming media data being presented in view of user-preference metadata.

The server (260) is shown in communication with data storage (286). In one embodiment, the data storage (286) may be a data center. In one embodiment, the contextualized data (e.g., the generated metadata tags) are stored at the data storage (286). However, the contextualized data may be stored at any storage device in communication with the second server (260). In one embodiment, and as shown, media metadata profile (288) and user specific metadata (294) are stored in the data storage (286). Further details regarding the process for contextualizing media data are provided below with reference to FIGS. 10 and 11.

In one embodiment, the secondary client machine (250) is configured to transmit a notification to the primary client machine (220) during the presentation of streaming media content. The transmitted notification signals to the primary client machine (220) that there is interest in receiving relevant content during the presentation of the streaming media content. Accordingly, a notification from the secondary client machine (250) may initiate a dynamic interaction process between the primary client machine (220) and the second server (260) to identify relevant content.

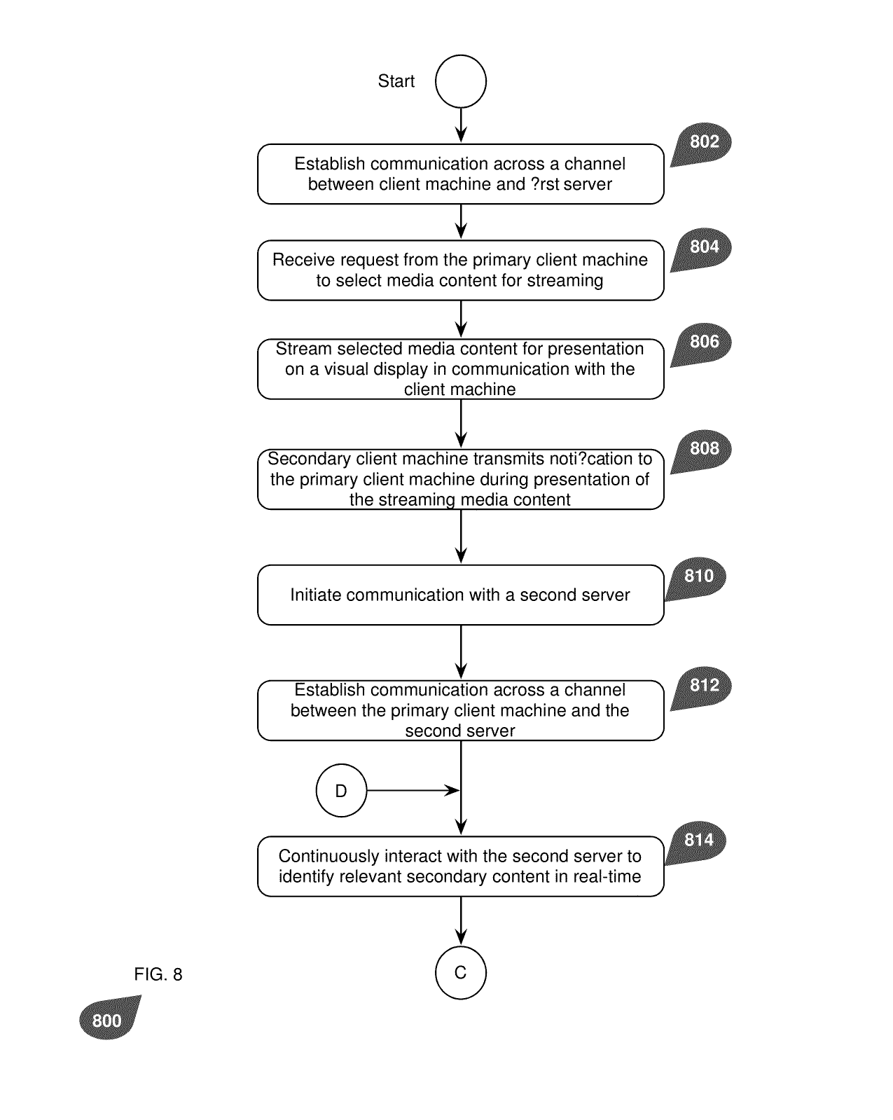

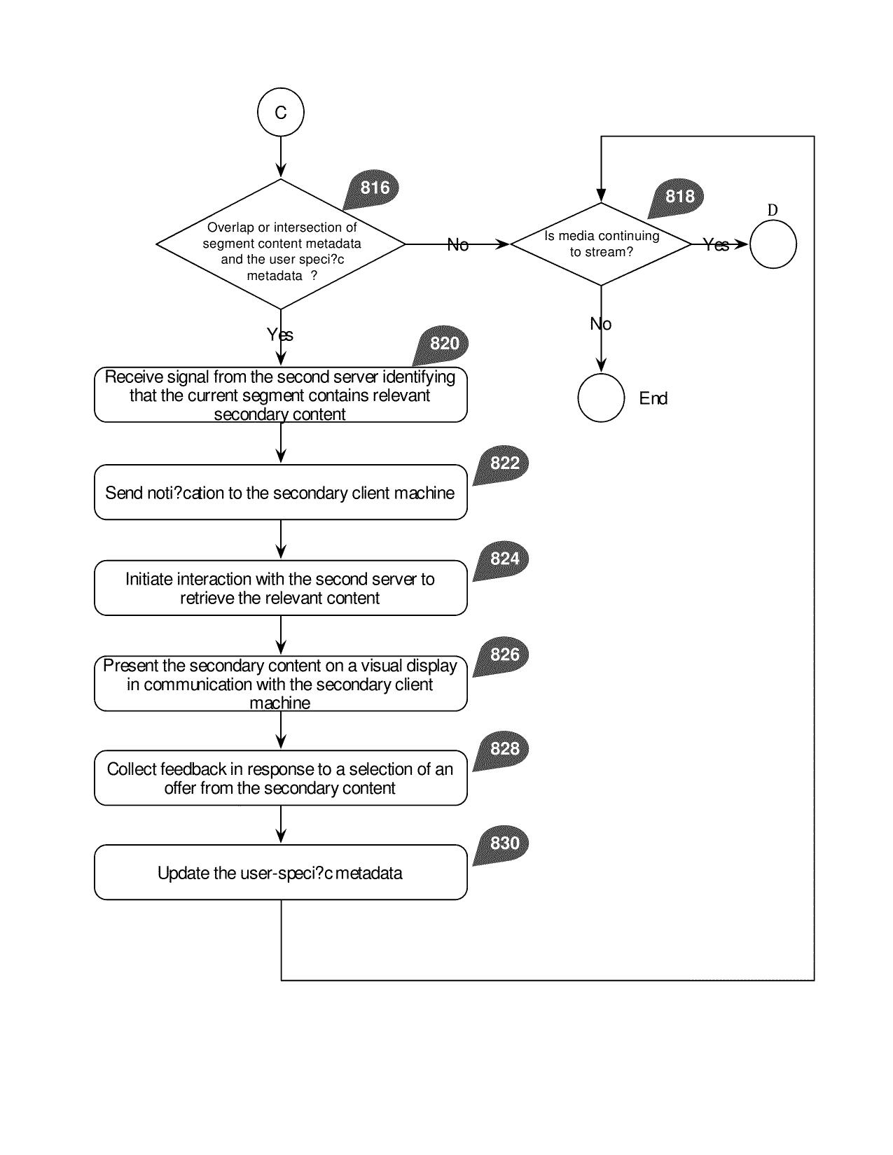

In one embodiment, and as shown, a first application, APP₀ (290), is local to the primary client machine (220), and a second application, APP₁ (292), is local to the secondary client machine (250). Similar to the system of FIG. 1, APP₀ (290) and APP₁ (292) are provided with the same functionality as described in FIG. 1. However, in the system configuration of FIG. 2, the secondary content (e.g., relevant advertisements, offers, etc.) is displayed on visual display (258) associated with the secondary client machine (250), while the streaming media content continues to be presented on the presentation device (230). Specifically, in response to the primary client machine (220) receiving a signal from the second server (260) that there is relevant secondary content, the primary client machine (220) notifies the secondary client machine (250) of the relevant secondary content, and the secondary client machine (250) initiates an interaction with the second server (260) to retrieve the relevant secondary content. In one embodiment, the signal and notification include a token identifying the relevant content. Further details with respect to the processes performed by the system of FIG. 2 are discussed with reference to FIG. 8. Thus, in this system configuration, relevant secondary content may be forwarded to the secondary client machine (250) for future viewing. Accordingly, communication of the secondary content continues in real-time with respect to the streaming and displaying of the streaming media content on the presentation device (230), with the secondary content transmitted to the secondary client machine (250) for viewing on the visual display (258).

It is understood that viewing streaming media content on a television may be a social event with friends and/or family. However, what may be of interest to one viewer may not be of interest to another viewer. For example, one viewer may enjoy eating pizza, and another viewer may be interested in traveling. The systems of FIGS. 1 and 2 may be expanded to support secondary content delivery to multiple (secondary) client machines, each in communication with the first and second servers. In one embodiment, each of the client machines is configured with respective versions of APP₀ and APP₁. APP₁ may be embedded within the client machines, or may be hosted on a separate machine and in separate communication with each secondary client machine. This configuration enables each client machine to receive secondary content that is relevant to the client machine and the user metadata that is related to the different users of the different client machines. The offers and advertisements are based on the segment content metadata and the user metadata, and as such may cause the second server to deliver different secondary content to the different client machines. Thus, as the video is being streamed, each user may be targeted with individualized relevant content, even though each user is consuming the same primary media content. Accordingly, the system continues to change, and the changes may be captured to maintain continued real-time interaction with the primary content and to return relevant secondary content to the client machine(s).

As shown in the system of FIGS. 1 and 2, the relevant content delivery system is configured to concurrently present both streaming media and secondary content. The streaming media and secondary content may be presented on the same visual display with interference or overlap of the presentations, or on separate visual displays. The displayed secondary content may include one or more items which may be stand alone content, content that is linked to an external merchant, or content that is linked to a commercial marketplace. In one embodiment, further interaction may be performed in order to access additional information associated the secondary content. For instance, a secondary item may be displayed as a hyperlink, such that interaction with the hyperlink will cause a display of a corresponding website on the client machine. In one embodiment, interaction with a hyperlink causes a web browser program or application to autonomously access the website pursuant to the hyperlink. Thus, the systems of FIGS. 1 and 2 may integrate Internet-based hyperlink functionality to support and improve electronic commerce. Accordingly, the systems of FIGS. 1 and 2 support the viewing of streaming media content on a visual display associated with a primary client device, while having relevant offer and advertisement alerts associated with the streaming media content generated and displayed in real-time either to the visual display of the primary device, as shown in FIG. 1, or to a secondary device, as shown in FIG. 2.

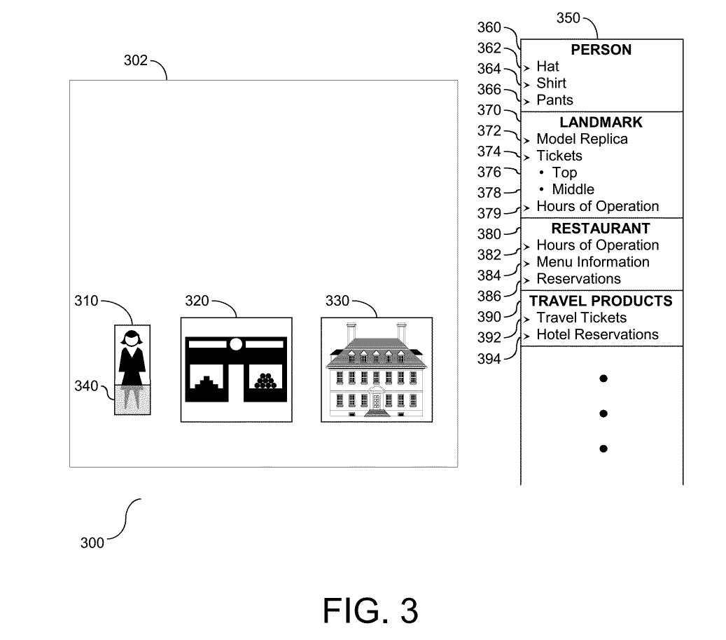

FIG. 3 illustrates a diagram (300) of an image (302) and a secondary window (350) presenting relevant content associated with streaming media, such as relevant offers, advertisements, and/or other information associated with a scene or frame of the video. The relevant content been identified by the system of FIGS. 1 and/or 2. In this example, the streaming media is a video, and a person (310), a commercial establishment (320), and a famous landmark (330) are depicted in a frame or scene of video. All relevant content associated with the person (310), establishment (320), and landmark (330) is presented and identified. For illustrative purposes, the components shown in image (300) are identified as separate selectable components. In one embodiment, a subsection of the image is selected for associated consumer product identification. For example, subsection (340) is associated with the person (310) illustrated in the image. Relevant content associated with the person is shown at (360) with selectable components hat (362), shirt (364), and pants (366) listed. In one embodiment, as each selectable component is viewed or identified with a pointing device, the secondary window (350) may display product and/or service details, including but not limited to product identification, pricing, location to purchase, designer, etc. A selection within the secondary window may be followed by presentation of options associated with the product details, including but not limited to, product particulars such as size, colors, etc. Accordingly, as an image is viewed or selected, identifiable components are visually presented with product details.

Products associated with objects in the scene that are not necessarily visible in the scene are identified. For example, with regards to the famous landmark depicted in the scene (330), relevant content associated with the landmark is shown at (370) with selectable components model replica (372), purchasable tickets (374), such as tickets to the top (376) or middle of the landmark (378), and hours of operation (379). In one embodiment, reservation information is displayed with the scene (302). For example, reservation information may be displayed regarding a reservation for admission to an establishment (320). In this example, the establishment (320) is a restaurant, and relevant content associated with the restaurant is shown at (380) with selectable components hours of operation (382), menu information (384) and reservations (386), which may include information including providing access to make a reservation. In one embodiment, where the structure (330) and/or the establishment (320) are associated with a particular location, a geographic identifier is implemented to present location sensitive products, such as relevant travel related products (390) associated with the particular location e.g. travel tickets to the particular location (392) and/or reservations at a hotel near the particular location (394). Accordingly, relevant secondary content associated with primary media content is identified and displayed.

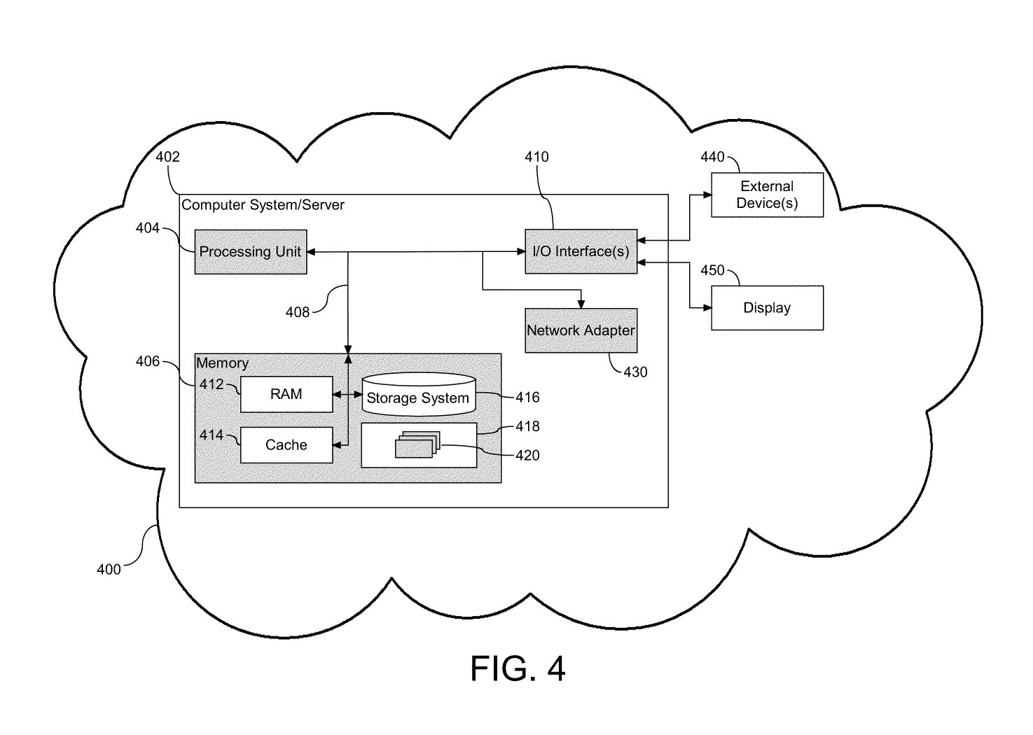

With reference to FIG. 4, a block diagram (400) is provided illustrating an example of a computer system/server (402), hereinafter referred to as a node (402). Node (402) may be a server associated with a client machine, streaming media provider, contextual personalized content delivery service, or streaming media device, as discussed herein above. Node (402) is operational with numerous other general purpose or special purpose computing system environments or configurations. Examples of well-known computing systems, environments, and/or configurations that may be suitable for use with node (402) include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and filesystems (e.g., distributed storage environments and distributed cloud computing environments) that include any of the above systems or devices, and the like.

Node (402) may be described in the general context of computer system-executable instructions, such as program modules, being executed by a computer system. Generally, program modules may include routines, programs, objects, components, logic, data structures, and so on that perform particular tasks or implement particular abstract data types. Node (402) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, node (402) is shown in the form of a general-purpose computing device. The components of node (402) may include, but are not limited to, one or more processors or processing units (404), a system memory (406), and a bus (408) that couples various system components including system memory (406) to processor (404). Bus (408) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Node (402) typically includes a variety of computer system readable media. Such media may be any available media that is accessible by node (402) and it includes both volatile and non-volatile media, removable and non-removable media.

Memory (406) can include computer system readable media in the form of volatile memory, such as random access memory (RAM) (412) and/or cache memory (414). Node (402) further includes other removable/non-removable, volatile/non-volatile computer system storage media. By way of example only, storage system (416) can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus (408) by one or more data media interfaces. As will be further depicted and described below, memory (406) may include at least one program product having a set (e.g., at least one) of program modules that are configured to carry out the functions of the embodiments described herein.

Program/utility (418), having a set (at least one) of program modules (420), may be stored in memory (406) by way of example, and not limitation, as well as an operating system, one or more application programs, other program modules, and program data. Each of the operating systems, one or more application programs, other program modules, and program data or some combination thereof, may include an implementation of a networking environment. Program modules (420) generally carry out the functions and/or methodologies of embodiments described herein. For example, the set of program modules (420) may include at least one module that is configured to contextualize media, or present relevant content during streaming of the media, as described herein.

Node (402) may also communicate with one or more external devices (440), such as a keyboard, a pointing device, etc.; a display (450); one or more devices that enable a user to interact with node (402); and/or any devices (e.g., network card, modem, etc.) that enable node (402) to communicate with one or more other computing devices. Such communication can occur via Input/Output (I/O) interface(s) (410). Still yet, node (402) can communicate with one or more networks such as a local area network (LAN), a general wide area network (WAN), and/or a public network (e.g., the Internet) via network adapter (430). As depicted, network adapter (430) communicates with the other components of node (402) via bus (408). In one embodiment, a filesystem, such as a distributed storage system, may be in communication with the node (402) via the I/O interface (410) or via the network adapter (430). It should be understood that although not shown, other hardware and/or software components could be used in conjunction with node (402). Examples, include, but are not limited to: microcode, device drivers, redundant processing units, external disk drive arrays, RAID systems, tape drives, and data archival storage systems, etc.

In one embodiment, node (402) is a node of a cloud computing environment. As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

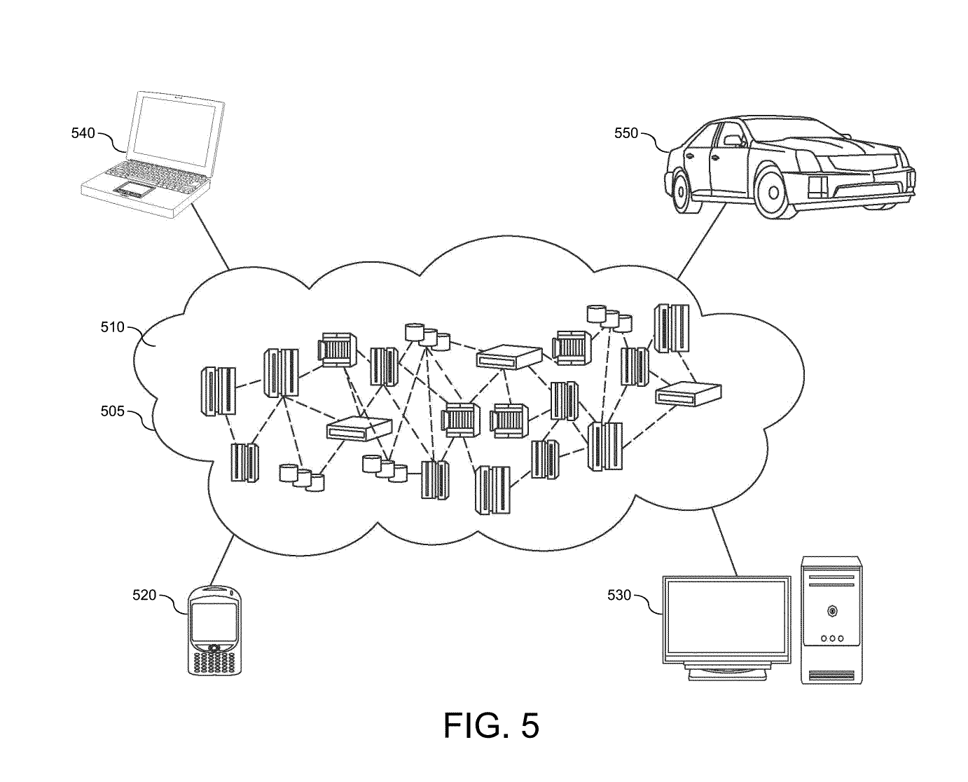

Referring now to FIG. 5, an illustrative cloud computing network (500) is provided. As shown, cloud computing network (500) includes a cloud computing environment (505) having one or more cloud computing nodes (510) with which local computing devices used by cloud consumers may communicate. Examples of these local computing devices include, but are not limited to, personal digital assistant (PDA) or cellular telephone (520), desktop computer (530), laptop or tablet computer (540), and/or automobile computer system (550). Individual nodes within nodes (510) may further communicate with one another. They may be grouped (not shown) physically or virtually, in one or more networks, such as Private, Community, Public, or Hybrid clouds as described hereinabove, or a combination thereof. This allows cloud computing environment (500) to offer infrastructure, platforms and/or software as services for which a cloud consumer does not need to maintain resources on a local computing device. It is understood that the types of computing devices (520)-(550) shown in FIG. 5 are intended to be illustrative only and that the cloud computing environment (505) can communicate with any type of computerized device over any type of network and/or network addressable connection (e.g., using a web browser).

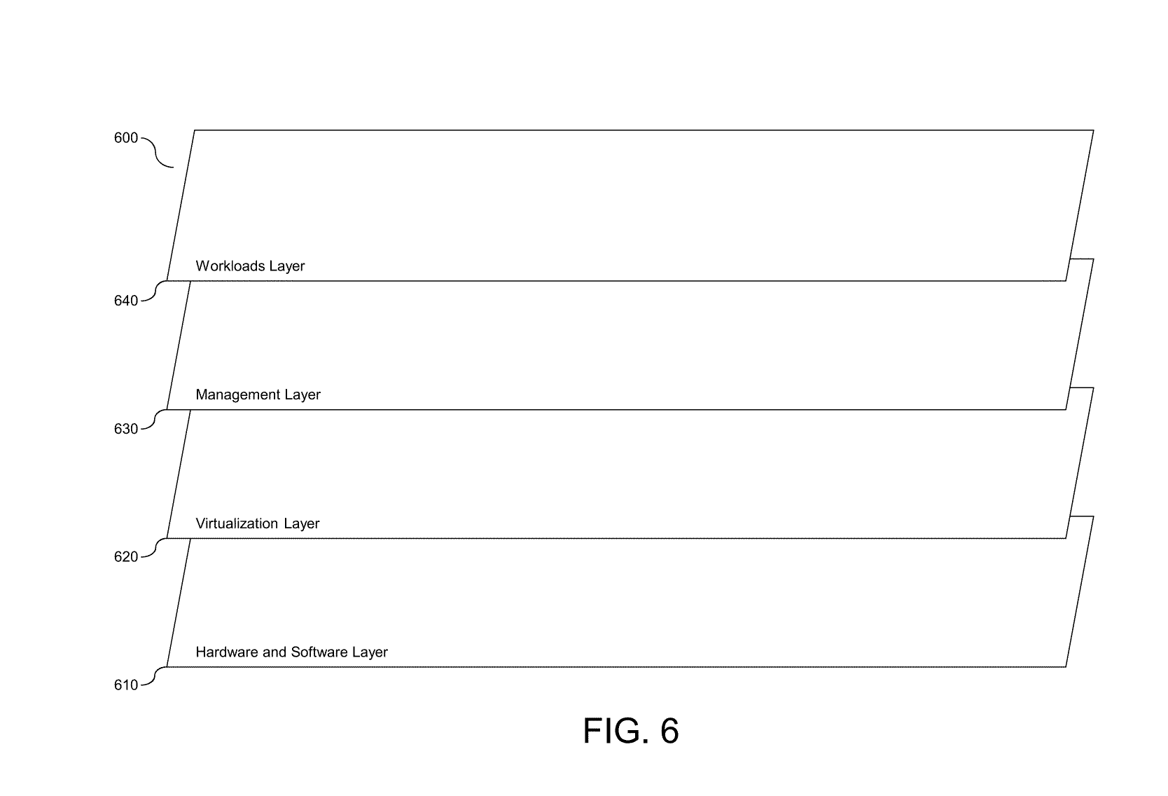

Referring now to FIG. 6, a set of functional abstraction layers provided by cloud computing network (600) is shown. It should be understood in advance that the components, layers, and functions shown in FIG. 6 are intended to be illustrative only, and the embodiments are not limited thereto. As depicted, the following layers and corresponding functions are provided: hardware and software layer (610), virtualization layer (620), management layer (630), and workload layer (640). The hardware and software layer (610) includes hardware and software components. Examples of hardware components include servers, storage devices, networks and networking components. Examples of software components include network application server software, and database software.

Virtualization layer (620) provides an abstraction layer from which the following examples of virtual entities may be provided: virtual servers; virtual storage; virtual networks, including virtual private networks; virtual applications and operating systems; and virtual clients.

In one example, management layer (630) may provide the following functions: resource provisioning, metering and pricing, user portal, service level management, and SLA planning and fulfillment. Resource provisioning provides dynamic procurement of computing resources and other resources that are utilized to perform tasks within the cloud computing environment. Metering and pricing provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer (640) provides examples of functionality for which the cloud computing environment may be utilized. Examples of workloads and functions which may be provided from this layer include, but are not limited to: mapping and navigation; software development and lifecycle management; virtual classroom education delivery; data analytics processing; transaction processing; and streaming media support within the cloud computing environment.

In the shared pool of configurable computer resources described herein, hereinafter referred to as a cloud computing environment, files may be shared among users within multiple data centers, also referred to herein as data sites. A series of mechanisms are provided within the shared pool to provide decision making controls for access to one or more records based upon associated record access and inherent characteristics of privacy. Three knowledge bases are employed with respect to consent management, including importance, sensitivity, and relevance. Analytical techniques employ the knowledge bases to assist with making access control decisions.

With reference to FIG. 7, a flowchart (700) is provided illustrating a process for supporting the dynamic presentation of content based on streaming media. Communication across a channel between a client machine and a first server is established (702). As shown and discussed in FIGS. 1 and 2, the client machine may be a personal computer, a tablet, a mobile telecommunication device (e.g., a smart phone), or any other device capable of presenting streaming media, and the first server (e.g., a streaming media provider) is in communication with a media library. The first server receives a request from the client machine to select media content for streaming (704). The selected media content is streamed to the client machine for presentation on a visual display in communication with the client machine (706). Communication across a channel between the client machine and a second server is established (708). In one embodiment, the communication is established in response to the selection of the media content at step (704). As shown and discussed in FIG. 1, the second server (e.g., a contextual personalized content delivery service) is in communication with data storage that maintains contextualized media data, such as a media profile comprising metadata tags corresponding to respective segments of the media content.

While the selected media content is streaming, the client machine continuously interacts with the second server, in real-time, to identify relevant secondary content (710). In one embodiment, step (710) includes comparing metadata tags associated with a current segment of the streaming content (i.e., segment content metadata), such as a current scene or frame, to the user specific metadata. For example, the user specific metadata may include user preference metadata, historical behavior metadata, algorithmic inference metadata, and user environment metadata, as discussed above in FIG. 1. The comparison may include determining an overlap or intersection among the categories of metadata. Further details of the comparison performed at step (710) are shown and described in FIG. 9. Accordingly, the first aspect of interaction with the streaming content pertains to identification of relevant content as defined by both the streaming media and the user specific metadata.

Following the comparison at step (710), it is determined if there is an overlap or an intersection of the segment content metadata and the user specific metadata (712). An overlap or intersection of the metadata at step (712) is an indication of relevancy. A negative response to the determination at step (712) is followed by determining if the media is continuing to stream to the client machine (714). If the media is continuing to stream, the process returns to step (710) to identify relevant content in a subsequent segment of the streaming content, and if the media streaming has concluded, the process for interacting with the streaming media is concluded. Until such time as an overlap at step (712) is detected, the user may continue viewing the streaming media. If at step (712) it is determined that the video metadata and the user-specific metadata categories overlap or otherwise intersect, the streaming media device receives a signal from the second server identifying that the current segment of the streaming media contains relevant content (718), e.g. relevant secondary content. In one embodiment, and as discussed above in FIG. 1, the signal includes a token that may be in the form of a component associated source code, a flag as a component of a programming language data structure, or a similar configuration.

At step (718), it may be determined that there exists relevant secondary content associated with the scene, such as relevant offers, advertisements, etc., hereinafter referred to collectively as offers. For example, if the streaming media is a video with a current scene associated with a hamburger, it may be determined at step (718) that there are one or more offers or advertisements for hamburgers associated with at least one third party dining establishment in the geographic vicinity of the client machine as defined by the location of the client machine. Similarly, if the current scene is associated with a travel destination, it may be determined at step (718) that there are one or more offers for travel to the depicted scene if the user specific metadata suggests an interest in the travel destination.

Receipt of the signal enables the display of a visual indicator alert, such as a message, icon, etc., on the visual display in communication with the client machine (720). The visual indicator serves to indicate the existence of relevant content. To prevent an interruption of the presentation of the streaming media content, the alert displayed at step (720) is in a secondary region of the visual display of the client machine while the media content in streaming in a primary region of the visual display of the client machine. Either simultaneously with or after the alert is presented, the presentation of the relevant secondary content is initiated (722). The initiation may occur in various ways. For instance, the visual indicator may be an interactive element, and a user may be required to initiate presentation of the secondary content at step (722) by interacting with the alert. Such an initiation protocol may be implemented to allow the user an option to decline viewing the relevant content during the presentation of the streaming media. The secondary content is presented on the visual display (724). If the user declines the initiation of the secondary content at step (722) (e.g., by ignoring the alert, selecting a decline option, etc.), the media continues streaming without interruption. Thus, the initiation at step (722) may be an optional event. In an alternative embodiment, the presentation of the secondary content is not optional, and the initiation at step (722) is autonomous.

Regardless of whether the user accepts initiation of the secondary content at step (722), or the initiation is autonomous, the secondary content is displayed on the visual display in communication with the client machine (724). In one embodiment, there may be more than one relevant offer for display. In one embodiment, the relevant offer(s) may be presented sequentially or consecutively. Feedback may be collected in response to a selection of an offer from the presented secondary content (726). The collected feedback may be used to update the user-specific metadata (728), followed by a return to step (714). The process shown herein continues until such time as the content streaming concludes. Accordingly, as the media continues to stream, secondary content relevant to both the current user of the client machine and the current segment of the streaming is delivered to the client machine in real-time.

As shown herein, the secondary content is communicated to the client machine, and presented on a visual display in communication with the client machine. In one embodiment, the secondary content presentation is in the form of a uniform resource locator (URL) specifying a location of a source of the secondary content. Selection of the secondary content takes place by activating the URL, which in one embodiment may be a selection of the URL with an input device. The selection directs the client machine to a venue associated with the URL, which in one embodiment may take place across a communication channel separate from the streaming media. For example, in one embodiment, the visual display of the client machine may have a primary window for presentation of the streaming media and a secondary window for presentation of the offer. Selection of the URL may take place in the secondary window with the re-direction to the associated venue taking place in the secondary window or in a third window. In one embodiment, the windows for the streaming media and the secondary content and/or selection are separate windows that do not overlap or otherwise intersect. This enables the streaming content to be viewed without interruption.

Referring to FIG. 8, a flow chart (800) is provided depicting a process for supporting the dynamic presentation of content based on streaming media. Communication across a channel between a primary client machine and a first server is established (802). In one embodiment, the communication channel is a wireless communication channel. As shown and discussed in FIG. 2, the primary client machine may be a streaming media device, such as a set-top box, digital media player, or any device configured to present media content from a source over a network (e.g., a cable provider, satellite provider, Internet provider, etc.). The primary client machine may be in communication with a presentation device for presenting streaming media content. In one embodiment, the presentation device is a television. However, the device may be a personal computer, a tablet, a mobile telecommunication device (e.g., a smart phone), or any other device capable of presenting streaming media. The first server receives a request from the primary client machine to select media content for streaming (804). The selected media content is streamed to the primary client machine for presentation on the presentation device (806), e.g. a visual display in communication with the primary client machine. In one embodiment, the communication is established in response to the selection of the media content at step (804). As shown and discussed in FIG. 2, the second server (e.g., a contextual personalized content delivery service) is in communication with data storage that maintains contextualized media data, such as a media profile comprising metadata tags corresponding to respective segments of the media content.

A secondary client machine is in communication with the primary client machine and the second server. The secondary client machine may be a personal computer, a tablet, a mobile telecommunication device (e.g., a smart phone), or any other device capable of presenting content in accordance with the embodiments described herein. In one embodiment, the secondary client machine transmits a notification to the primary client machine during the presentation of the streaming media content (808). The transmitted notification signals to the primary client machine that there is interest in receiving relevant content during the presentation of the streaming media content. Thus, the notification at step (808) initiates a dynamic interaction between the primary client machine and the second server to identify relevant content (810), and communication across a channel between the primary client machine and a second server is established (812). While the selected media content is streaming, the primary client machine continuously interacts with the second server, in real-time, to identify relevant secondary content (814). In one embodiment, step (814) includes comparing metadata tags associated with a current segment of the streaming content (i.e., segment content metadata), such as a current scene or frame, to the user specific metadata. For example, the user specific metadata may include user preference metadata, historical behavior metadata, algorithmic inference metadata, and user environment metadata, as discussed above in FIG. 2. The comparison may include determining an overlap or intersection among the categories of metadata. Further details of the comparison performed at step (814) are shown and described in FIG. 9. Accordingly, the first aspect of interaction with the streaming content pertains to identification of relevant content as defined by both the streaming media and the user specific metadata.

Following the interaction at step (814), it is determined if there is an overlap or an intersection of the segment content metadata and the user specific metadata (816). An overlap or intersection of the metadata at step (816) is an indication of relevancy. A negative response to the determination at step (816) is followed by determining if the media is continuing to stream to the primary client machine (818). If the media is continuing to stream, the process returns to step (814) to continue the interaction in support of identification of relevant content in a subsequent segment of the streaming content. Similarly, if the response to the determination at step (818) is negative, it is determined that the media streaming has concluded, and as such, the process for interacting with the streaming media is concluded. Until such time as an overlap at step (816) is detected, the user may continue viewing the streaming media. If it is determined at step (816) that the video metadata and the user-specific metadata categories overlap or otherwise intersect, the primary client machine receives a signal from the second server identifying that the current segment of the streaming media contains relevant secondary content (820). In one embodiment, and as discussed above in FIGS. 1, 2, and 7, the signal includes a token that identifies the relevant secondary content in the context of the streaming media.

Instead of displaying the relevant content on the presentation device in communication with the primary client machine, the second server may be configured to present the relevant content on the secondary client machine. Specifically, the primary client machine sends a notification to the secondary client machine (822). In one embodiment, the notification includes the token. Following the notification at step (822), the secondary client machine initiates an interaction with the second server to retrieve the relevant content (824), and the relevant content is presented on a visual display in communication with the secondary client machine (826). As discussed in FIG. 7, feedback may be collected in response to a selection of an offer from the presented secondary content (828). The collected feedback may be used to update the user-specific metadata (830), followed by a return to step (818). The process shown herein continues until such time as the content streaming concludes. Accordingly, the process of FIG. 8 allows forwarding of secondary content, such as relevant offers, to a separate device for viewing.

As shown herein, the secondary content is communicated to the secondary client machine, and presented on a visual display in communication with the secondary client machine. In one embodiment, the secondary content presentation is in the form of a uniform resource locator (URL) specifying a location of a source of the secondary content. Selection of the secondary content takes place by activating the URL, which in one embodiment may be a selection of the URL with an input device. The selection directs the client machine to a venue associated with the URL, which in one embodiment may take place across a communication channel separate from the streaming media. For example, in one embodiment, the visual display of the client machine may have a primary window for presentation of the streaming media and a secondary window for presentation of the offer. Selection of the URL may take place in the secondary window with the re-direction to the associated venue taking place in the secondary window or in a third window.

Referring to FIG. 9, a diagram (900) is provided depicting the relationship of client metadata and streaming media metadata. As shown, there are three areas, Area₁ (910), Area₂ (920), and Area₃ (930), each area representing different categories of metadata. Area₁ (910) and Area₃ (930) depicts different categories of metadata specific to the client machine, and in one embodiment related to a user logged onto the client machine. Specifically, Area₁ (910) depicts metadata pertaining to user preferences, historical behavior, and algorithmic inference metadata (912); and Area₃ (930) depicts user environment metadata (932). Area₂ (920), which is related to the streaming content, depicts video scene content metadata (922). As the video is streamed to the client machine, one or more frames or scenes of the streaming video may have associated metadata (922). In the example shown herein, an overlap of the three categories of metadata is shown at (950), and the overlap represents relevant content based on the intersection of the three categories of metadata. In one embodiment, a minimum overlap of user metadata represented in either Area₁ (910) or Area₃ (930) with streaming content metadata in Area₂ (920) is required to be deemed relevant.

The metadata shown and represented in FIG. 9 is not static. Rather, the depiction shown in FIG. 9 pertains to the three categories of data as related to a scene or frame in the streaming media. Referring to FIG. 10, a flow chart (1000) is provided depicting a process for generating metadata for streaming media content. As shown, it is determined if a metadata profile for the media content is available (1002). A positive response to the determination at step (1002) concludes the process of generating video metadata, as the previously created video profile is present. However, if the video profile does not exist, as demonstrated by a negative response to the determination at step (1002), a media profile is created (1004). After the media profile is created, an analysis of the streaming media is initiated (1006). In one embodiment, the streaming media is a video having a video data component, an auxiliary content data component (e.g., captioning data), and an audio data component. The components of a current segment (e.g., scene) are analyzed, including any video data (1008), auxiliary content data (1010), and audio data (1012). As the components are analyzed, associated media metadata is added for the segment is added to the media profile (1014), and in one embodiment populated to Area₂ (920) for each scene. In one embodiment, steps (1008)-(1014) may be performed concurrently or consecutively. Following the analysis at steps (1008)-(1012) and augmentation of the media metadata at step (1014), it is determined if the streaming media contains any more segments to be analyzed (1016). A positive response to the determination at step (1016) is followed by a return to step (1006) to initiate the analysis of the next segment, and a negative response concludes the process of analyzing the video and populating metadata in an associated media metadata profile. As shown herein, the analysis takes place on a per-segment basis. In one embodiment, a different category of granularity may be employed, and as such the granular level of segments should not be considered limiting. Accordingly, metadata tags may be generated from data components of streaming media, and stored within a media profile.

The tags generated by the process of FIG. 10 represent annotations to describe the subject matter associated with a segment. For example, the generated tags may describe various aspects of the segment, including but not limited to location, visible objects, associated events, specific establishment or venues, associated activities, audio soundtrack, background music, topics of conversation, etc. That is, the generated tags may include identifiers, such as establishment identifiers, geographic identifiers, etc. For example, a scene or frame of a video may depict two people eating dinner at a restaurant. Metadata tags may be generated to describe the venue itself, such as the restaurant and related features (e.g., cuisine, rating, type of service, visible objects within the scene, etc.), the location of the restaurant (e.g., neighborhood, city, town, etc.), and activities associated with the frame (e.g., eating dinner, discussing a specific topic). Furthermore, metadata tags may be generated to describe a song playing at the restaurant. Accordingly, metadata tags are generated and stored in a profile to annotate media content.

As previously discussed, the goal of the secondary content, such as offers, advertisements, etc., is that it be relevant to the user in that they are directly related to the content as it is being streamed. Thus, the media profile of FIG. 10 may be refined or enhanced based on contributions obtained from external sources. Referring to FIG. 11, a flow chart (1100) is provided illustrating a process for adding metadata for streaming media. As suggested above, the metadata tags need to be associated with an appropriate segment of the streaming media in order to identify secondary content. For instance, as discussed in FIG. 10, the metadata tags may be organized with a media metadata profile by respective segments.

As shown, metadata and media content is added from one or more third parties (1102). In one embodiment, the metadata is added via crowd-sourcing from a plurality of third party sources. A relevant media metadata profile associated with the metadata and content is identified (1104). As discussed herein, the profile contains metadata associated with respective segments of the media content, and the profile needs to be appended with the metadata at one or more corresponding segments. In addition, a relevant segment of the media, such as a scene or frame, is identified (1106). The profile of the relevant segment is appended with the metadata (1108). More specifically, at step (1108) metadata for the media segment is appended in the media metadata profile. It is then determined if there is another segment in the media content that is associated with the added metadata (1110). A positive response to the determination at step (1010) is followed by a return to step (1106) to identify a relevant media segment, and a negative response to the determination at step (1108) is followed by assessing if there are any more relevant media metadata profiles (1112). A positive response to the determination at step (1112) is followed by a return to step (1104) for identification of one or more relevant media metadata profiles for the next identified content, and a negative response to the determination at step (1112) concludes the process of adding metadata tags to an associated media metadata profile. Accordingly, one or more third parties may enhance metadata tag generation in a media metadata profile by appending metadata tags to one or more segments of media content.

The embodiments described herein allow for the dissemination of user-specific relevant content. Such user-specific relevant content may be in the form of targeted advertising. For example, two different users may be watching a streaming video that is set in Hawaii. The relevance data associated with the first user may determine that the first user is an avid traveler, and the user may receive a notification or alert for relevant content that includes a travel package to Hawaii. The relevance data associated with the second user may result in the issuance of a notification or alert for different relevant content, such as an advertisement for Hawaiian shirt depicted in within a scene of the streaming video. The Hawaiian shirt content may be transmitted to the user based on seasonal information. For example, the Hawaiian shirt advertisement may be transmitted only if it is summer where the consumer is located (e.g., if the consumer is located in the northern hemisphere and is streaming the video in July, the location information will determine that it is summer). Thus, the relevant content determination for a particular consumer may be based on an analysis of video metadata tags against metadata associated with a particular user, in order to determine which offer alert may be of value to the particular consumer of a particular geographical location. Accordingly, relevant content is customized based on user preference information and environmental information, such as location, weather, etc., to increase the probability of transmitting relevant content to a particular consumer.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including a variety of programming language such as Java, Javascript, Swift, Smalltalk, Objective C, C#, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The functional unit(s) described in this specification has been labeled with tools in the form of manager(s). A manager may be implemented in programmable hardware devices such as field programmable gate arrays, programmable array logic, programmable logic devices, or the like. The manager(s) may also be implemented in software for processing by various types of processors. An identified manager of executable code may, for instance, comprise one or more physical or logical blocks of computer instructions which may, for instance, be organized as an object, procedure, function, or other construct. Nevertheless, the executable of an identified manager need not be physically located together, but may comprise disparate instructions stored in different locations which, when joined logically together, comprise the managers and achieve the stated purpose of the managers and directors.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. Accordingly, relevant secondary content may be presented based on metadata tags associated with previously contextualized video data.

### Alternative Embodiment(s)

It will be appreciated that, although specific embodiments of the invention have been described herein for purposes of illustration, various modifications may be made without departing from the spirit and scope of the invention. Identification of product and service details may occur on different visualizations, including but not limited to, mobile applications and non-mobile applications. With respect to the mobile applications, product and/or service details may be tied with the geographic location of the mobile device, and provide directions to a retail establishment associated with the product or service details. As described above, the generated tags include identifiers associated with the streaming content. The tags may be associated with an express characteristic, an inherent characteristic, or an ancillary characteristics of one or more objects in the streaming media. For example the tags may be associated with an activity being depicted in the streaming media, a topic associated with the streaming media, or an object present in the streaming media. The tags may be based on an explicit or implicit characteristic of the streaming media. Accordingly, the scope of protection of the embodiments is limited only by the following claims and their equivalents.

What is claimed is:

1. A system comprising:
a first device comprising a first processing unit in communication with first memory, and a first functional unit in communication with the first processing unit, wherein the first functional unit comprises one or more tools embodied therewith;
a second device in communication with the first device across a network, wherein the second device comprises a second processing unit in communication with second memory, and a second functional unit in communication with the second processing unit, wherein the second functional unit comprises one or more tools embodied therewith;
the first device to contextualize data associated with media content, including the first device to generate one or more metadata tags associated with respective segments of the media content;
the second device, in response to a request to stream the media content on the second device, to receive the media content across the network from a media provider, and present the received media content;
the first device to dynamically interact with the second device during the presentation of the media content, including the first device to perform an analysis based on the contextualized data, wherein the analysis of the current frame comprises the first device to compare the one or more generated metadata tags with user-specific metadata, and transmit a relevant content alert to the second device based on the analysis; and
the second device to cause a presentation of relevant content on a visual display.

2. The system of claim 1, wherein the relevant content is presented on a visual display in communication with the second device, and wherein the presentation of the relevant content mitigates interference with the presentation of the received media content.

3. The system of claim 1, further comprising a third device in communication with the first and second devices, the third device comprising a processing unit in communication with third memory, and a third functional unit in communication with the third processing unit, wherein the third functional unit comprises one or more tools embodied therewith, and wherein the relevant content is displayed on the third device.

4. The system of claim 3, further comprising the third device to transmit a notification to the second device that there is interest in receiving relevant content during the presentation of the received media content, wherein the transmitted notification initiates the dynamic interaction between the first and second devices.

5. The system of claim 1, wherein the one or more generated metadata tags comprise one or more establishment identifiers associated with the video, and wherein the relevant content comprises information regarding the establishment identifier selected from the group consisting of: additional product information, reservation information, event information, and any combination thereof.

6. The system of claim 1, wherein the one or more generated metadata tags comprise one or more geographic identifiers associated with the data transmission, and wherein the relevant content comprises information regarding the geographic identifier selected from the group consisting of: consumer product information, travel related information, event information, and any combination thereof.

7. The system of claim 1, wherein the one or more generated metadata tags comprise one or more object identifiers associated with the data transmission, and wherein the relevant content comprises information regarding the object identifier selected from the group consisting of: an associated activity, a topic, an object, and combinations thereof.

8. The system of claim 1, further comprising the first device compare the one or more generated metadata tags with user-specific metadata selected from the group consisting of: preference, historical behavior, algorithmic inferences, environmental, and combinations thereof.

9. The system of claim 1, wherein the user-specific metadata comprises location metadata associated with the second device, and further comprising the first device to integrate location based content targeting, including the first device to compare a first geographic location associated with the location metadata with a second geographic location associated with relevant content location, wherein the relevant content alert is transmitted in response to a distance between the first and second geographic locations.

10. A computer program product comprising a first computer-readable non-transitory storage medium having first computer readable program code embodied thereon, and a second computer-readable non-transitory storage medium having second computer readable program code embodied thereon, wherein the first storage medium is associated with a first device and the second storage medium is associated with a second device, wherein the first and second devices are in communication across a network, wherein the first program code is executable by a first processor of the first device and second program code executable by a second processor of the second device to present relevant content associated with streaming media content, and wherein the execution comprises:
first program code to contextualize data associated with media content, including first program code to generate one or more metadata tags associated with respective segments of the media content;
in response to a request to stream the media content on the second device, second program code to present media content received across the network from a media provider;
first program code to dynamically interact with the second device during the presentation of the media content, including the first program code to perform an analysis based on the contextualized data, including comparison of the one or more generated metadata tags with user-specific metadata, and transmission of a relevant content alert to the second device based on the analysis; and
second program code to cause a presentation of the relevant content on a visual display.

11. The computer program product of claim 10, wherein the relevant content is presented on a visual display in communication with the second device, and wherein the presentation of the relevant content mitigates interference with the presentation of the received media content.

12. The computer program product of claim 10, further comprising a third computer-readable non-transitory storage medium having third computer-readable program code embodied thereon, wherein the third storage medium is associated with a third device in communication with the first and second devices, and wherein the relevant content is displayed on the third device.

13. The computer program product of claim 11, further comprising third program code to transmit a notification to the second device that there is interest in receiving relevant content during the presentation of the received media content, wherein the transmitted notification initiates the dynamic interaction between the first and second devices.

14. The computer program product of claim 10, wherein the one or more generated metadata tags comprise one or more establishment identifiers associated with the video, and wherein the relevant content comprises information regarding the establishment identifier selected from the group consisting of: additional product information, reservation information, event information, and any combination thereof.

15. The computer program product of claim 10, wherein the one or more generated metadata tags comprise one or more geographic identifiers associated with the data transmission, and wherein the relevant content comprises information regarding the geographic identifier selected from the group consisting of: consumer product information, travel related information, event information, and any combination thereof.

16. The computer program product of claim 10, wherein the one or more generated metadata tags comprise one or more object identifiers associated with the data transmission, and wherein the relevant content comprises information regarding the object identifier selected from the group consisting of: an associated activity, a topic, an object, and combinations thereof.

17. The computer program product of claim 10, further comprising program code to compare the one or more generated metadata tags with user-specific metadata selected from the group consisting of: preference, historical behavior, algorithmic inferences, environmental metadata, and combinations thereof.

18. The computer program product of claim 10, wherein the user-specific metadata comprises location metadata associated with the second device, and further comprising first program code to integrate location based content targeting, including first program code to compare a first geographic location associated with the location metadata with a second geographic location associated with relevant content location, wherein the relevant content alert is transmitted in response to a distance between the first and second geographic locations.

19. A method comprising:
a first device contextualizing data associated with media content, including generating one or more metadata tags associated with respective segments of the media content;
in response to a request to stream the media content on a second device, the second device receiving the media content across the network from a media provider, and presenting the received media content;
the first device dynamically interacting with the second device during the presentation of the received media content, including the first device performing an analysis based on the contextualized data, wherein the analysis includes comparing the generated metadata tags with user-specific metadata, and transmitting a relevant content alert to the second device based on the analysis; and
the second device causing a display of the relevant content on a visual display.

20. The method of claim 19, wherein the relevant content is presented on a visual displayed in communication with the second device, and wherein the presentation of the relevant content mitigates interference with the presentation of the received media content.

21. The method of claim 19, wherein the relevant content is presented on a third device in communication with the first and second devices.

22. The method of claim 21, further comprising the third device transmitting a notification to the second device that there is interest in receiving relevant content during the presentation of the received media content, wherein the transmitted notification initiates the dynamic interaction between the first and second devices.

23. The method of claim 21, wherein the one or more generated metadata tags comprise one or more establishment identifiers associated with the video, and wherein the relevant content comprises information regarding the establishment identifier selected from the group consisting of: additional product information, reservation information, event information, and any combination thereof.

24. The method of claim 21, wherein the one or more generated metadata tags comprise one or more geographic identifiers associated with the data transmission, and wherein the relevant content comprises information regarding the geographic identifier selected from the group consisting of: consumer product information, travel related information, event information, and any combination thereof.

25. The method of claim 19, wherein the one or more generated metadata tags comprise one or more object identifiers associated with the data transmission, and wherein the relevant content comprises information regarding the object identifier selected from the group consisting of: an associated activity, a topic, an object, and combinations thereof.

26. The method of claim 19, further comprising comparing the one or more generated metadata tags with wherein the user-specific metadata selected from the group consisting of: preference, historical behavior, algorithmic inferences, environmental, and combinations thereof.

27. The method of claim 19, wherein the user-specific metadata comprises location metadata associated with the second device, and further comprising the first device integrating location based content targeting, including comparing a first geographic location associated with the location metadata with a second geographic location associated with relevant content location, wherein the relevant content alert is transmitted in response to a distance between the first and second geographic locations.
